(19) United States
(12) Patent Application Publication
(10) Pub. No.: US 2013/0141690 A1
(43) Pub. Date: Jun. 6, 2013

(54) REFRACTIVE EYEWEAR

(71) Applicants: Richard Edward Taylor, Oxford (GB); David Nicholas Crosby, Oxford (GB); Owen Fletcher Reading, Oxford (GB); Joshua Silver, Oxford (GB); Gregor Allan Storey, Oxford (GB)

(72) Inventors: Richard Edward Taylor, Oxford (GB); David Nicholas Crosby, Oxford (GB); Owen Fletcher Reading, Oxford (GB); Joshua Silver, Oxford (GB); Gregor Allan Storey, Oxford (GB)

(21) Appl. No.: 13/643,833

(22) PCT Filed: Apr. 26, 2011
(86) PCT No.: PCT/GB2011/050815

§ 371 Date: Feb. 6, 2013

(30) Foreign Application Priority Data
Apr. 26, 2010 (GB) 1006913.6

(51) Int. Cl. G02C 7/08; G02B 3/14

(52) U.S. Cl. CPC G02C 7/08; G02B 3/14
USPC 351/159.39; 351/159.68; 351/159.01; 351/159.73

(57) ABSTRACT

An optical apparatus (1) for wearing by a human user comprises one or more variable power lenses (4), means (10) for adjusting the power of the variable power lens (4), means (26) for capturing data representative of said adjustments, and means (28) for recording or transmitting the captured data.

This invention relates to eyewear which is adapted to cope with fluctuations in the refractive state of a person's eyes. It relates in particular to eyewear which has an adjustable optical power.

Normal human eyes have relatively stable refractive states when viewing objects at a distance. The eyes of younger people, generally below the age of forty, are able to change their refractive state sufficiently such that focusing on nearby objects is possible. The natural progressive age-related loss of this ability is known as presbyopia. Furthermore, it is also known that people may suffer relatively fixed refractive errors, known variously as ‘short-’ or ‘near-sightedness’ or ‘long-’ or ‘far-sightedness’. This may be corrected easily with appropriately configured eyeglasses or contact lenses, or with refractive surgery, e.g., LASIK (Laser-Assisted In Situ Keratomileusis), LASEK (Laser-Assisted Sub-Epithelial Keratectomy) or radial keratectomy.

There is some evidence to suggest that some people experience short term excursions in the refractive state of their eyes, e.g. over the course of a day which is beyond the small, normal day-to-day changes that are expected in, but rarely apparent to, other people. Such excursions are not fully understood but the quality of life of people suffering from such refractive excursions is seriously impaired by this condition due to the unavailability of a suitable correction device and the unsuitability of currently known refractive error treatments such as eyeglasses.

One possible factor in the occurrence of refractive excursions is diabetes. It is hypothesised that changes in blood glucose levels result in changes in the refractive state of a diabetic's eyes. Studies in this area have relied on measuring both blood glucose levels and refractive error at the same time using conventional methods, e.g. from a blood test taken by a phlebotomist and an eye test performed by an optometrist. In the case of refractive error, measurements are usually performed with an autorefractor of some sort. While this is a reliable and repeatable method, it is an inconvenient method requiring a patient's presence at a suitably equipped facility and is therefore not suited to the task of taking the many measurements over the course of a day or week that would be necessary to capture fully the characteristics of all the refractive excursions.

Another possible factor is a clinical history of refractive eye surgery. Fluctuating vision has been reported as a post operative complication by patients after having undergone various procedures such as radial keratectomy, LASIK and LASEK (n.b. keratectomy is performed with a keratome which is used to shave open a flap of the cornea, whereas keratotomy uses radial incisions into the cornea). Data on what constitutes fluctuating vision and the occurrence of, for example, “minor” compared with “major” fluctuating vision are rare, although what data that does exist on patients presenting with post-operative fluctuating vision, demonstrate that the occurrence of fluctuating vision in some cases (depending on the type of surgery and when it was performed) may be high. For example, a 1986 study showed that 42% of eyes examined one year after radial keratotomy showed variation of 0.50D-1.25D during the course of the day. There are also reports of individuals who experience up to 4D-5D of variation during the course of the day. Such a degree of fluctuating vision would be noticeable to an alert subject.

Temporary fluctuations in vision are also experienced by patients after other types of eye surgery, e.g. cataract removal which is typically followed by the insertion of an intraocular lens (IOL) to replace the original crystalline lens. These fluctuations may not follow the same patterns as for diabetics or refractive eye surgery patients, but may be more a gradual change in the refractive state as the patient's vision adjusts itself in the period after surgery.

The invention aims to bring benefits to this area.

From a first aspect the invention provides an optical apparatus for wearing by a human user comprising one or more variable power lenses, means for adjusting the power of the variable power lens, means for capturing data representative of said adjustments, and means for recording or transmitting the captured data.

The invention also extends to a method of correcting fluctuating vision of a human user, the method comprising providing an optical apparatus comprising one or more variable power lenses, adjusting the power of said lens to enable the human user to see in clear focus, capturing data representative of said adjustments, and recording or transmitting the captured data.

Thus it will be appreciated by those skilled in the art that in accordance with the present invention, not only is there provided vision-corrective equipment that allows sufferers of refractive excursions the appropriate refractive correction as their needs change throughout the day, or even over a longer period of time, e.g. after cataract removal, but it can also provide data on what changes are made that enables the monitoring and/or subsequent analysis of the user's refractive excursions.

The captured data can be compiled and used in diagnosis or therapy for the user and/or can be analysed for general study of conditions for which refractive excursions are a symptom.

The means for adjusting the power of the variable power lens could be automatic, e.g. comprising an onboard auto-refractor. However, in a preferred set of embodiments the means for adjusting the power of the variable power lens comprises means for allowing user adjustment of the power of the variable power lens. This allows for simplistic yet rapid and accurate way to achieve the user's ideal settings.

The ability to adjust the optical power of the lens gives the advantage that a “one size fits all” device can be provided so that a user can adjust as necessary to suit their refractive excursions and also their optical prescription, i.e. the user would first adjust the optical power of the lens to suit their refractive state and then when change in the refractive state of one or both eyes becomes apparent the user would further adjust the lens to be able to see with clear focus again. Alternatively the user could periodically adjust the optical power of the lenses to suit their refractive state as part of a simple refraction protocol. For example, the protocol could be a set of instructions including a Snellen chart given to a user by a clinician to a user so that the user can change the optical power of the lenses until they can see a particular line on the Snellen chart, or the protocol could be a set of instructions to change the optical power of the lenses by a certain amount at certain times throughout the day. This allows a relatively low cost device to be provided as the lenses do not have to be custom-made but can simply be adjusted by a user as necessary. The variable power lens also enables multiple users with different optical prescriptions to use the same apparatus which would be of benefit in an environment such as a hospital where viewing equipment may be used by many different patients.

In a set of preferred embodiments the optical apparatus resembles a pair of spectacles—that is comprising a frame adapted to be supported on the user's nose and ears. Although in the broadest scope of the invention a single lens could be provided for both eyes, in preferred embodiments separate lenses are provided for each eye. A single adjustment means for the two lenses may be provided. In these embodiments the two lenses are therefore linked or coupled such that a single adjustment can be made to alter the power of both lenses simultaneously. Alternatively separate adjustment means for each lens can be provided. This enables users who require different power of lens correction for each eye to be able to adjust the two lenses individually to suit first their prescription and second their refractive excursions which may be different for each eye.

The or each variable power lens may comprise: a fluid filled lens, an Alvarez-based lens, an electroactive lens, a diffractive lens or a diffractive Alvarez lens.

In one set of embodiments the adjustment means provides all the necessary adjustment of the lens, i.e. the adjustment range is large enough to be suitable for a large proportion of the population. Such an apparatus would therefore be suitable for hospital use or as a product for use at home. A large spherical power range, e.g. of +/−8 D, would enable the apparatus to be suitable for the vast majority of the population, although a narrower range, e.g. +/−4D would still be sufficient to cover a relatively large proportion of the population.

The different types of variable power lenses can be arranged to be able to provide a large adjustment range. In the set of embodiments in which a fluid filled lens is provided, a large adjustment range can be provided, though in some embodiments it may be necessary to include a double membrane structure (an optically transparent cavity closed off on both sides by flexible membranes) for the fluid cavity such that the optical power range is shared between two surfaces in order to prevent creep and other plastic deformation. A double membrane structure may also require some form of protection or cover for the membranes unless the membrane's own toughness or hardness is sufficient to protect it from damage, as dents in the membrane could otherwise be a problem. In other embodiments a single membrane structure (an optically transparent cavity closed off on one side by a flexible membrane) is able to provide a large enough adjustment range. Again, a single membrane structure may require some form of protection or cover over the membrane.

In the set of embodiment in which an Alvarez lens is provided, a large adjustment range is possible. For a given shape of the Alvarez lens, a greater adjustment range requires a greater translational distance and as a result wider lens elements in order to maintain a useable viewing area through the overlapping elements. The translational distance can be reduced by providing a more extreme surface form for the lens elements so that a greater change in the power of the lens is achievable for a smaller translational distance. A more extreme surface form may be more prone to aberrations as the lens elements are likely to be thicker and there are likely to be more pronounced surface reflections. The translational distance can also be reduced by using a higher refractive index material, though this is likely to result in greater colour dispersion from having a lower Abbe number. For the set of embodiments in which an Alvarez lens is provided, a protective cover may be used to protect the lens elements and adjustment means.

In the set of embodiments in which a variable electroactive lens is provided, this could comprise a stack of low power Fresnel liquid crystal elements, i.e. based on the form revealed by Blum, e.g. in WO 2010/015093. In this design the Fresnel surfaces are encased in a liquid crystal whose refractive index matches that of the Fresnel element, thereby rendering it optically invisible. The elements are turned ‘on’ by applying a voltage across the liquid crystal which causes a change in the liquid crystal's refractive index, hence causing the lens to become visible. A stack of lenses that offers the required range of power at sufficient resolution can provide a variable power lens.

A set of embodiments is also envisaged in which the lens comprises one or more fixed power prescription elements. Providing a fixed power prescription element allows a range of different power elements to be used according to the needs of the user. This means that the variable power lens could just be used for fine tuning of the optical power, i.e. the adjustment range is smaller than that of a device intended for universal application. This might make it suitable for a bespoke device for a particular user. Having a smaller adjustment range can result in number of benefits, e.g. if a fluid filled lens is provided only a small volume of fluid is needed, or if an Alvarez lens is provided only a small distance of translation between the two lens elements is needed.

Particularly in a variable power lens which is suitable for users with fluctuating vision, a fixed power prescription element can provide an offset spherical power for the variable lens. For example a variable power lens with an adjustment range of +/−6D could be combined with a −3D fixed power prescription element to give a variable power lens with a range of −9D to +3D. Therefore a fixed power prescription element can be used to bias the range of the variable power lens in the case where the distribution of required powers is skewed. This enables a variable power lens with a smaller range to cover a wider proportion of people than a lens with a wider range as overall a larger range of lens powers will be accessible. For example the apparatus could comprise a fixed power prescription element matching the power of the user's average prescription and a variable power lens with a wide enough range to cover the user's refractive fluctuations.

If a fixed power prescription element is provided, the prescription element can comprise one or more components from a spherical correction, a cylinder and axis correction or any other higher order aberration correction. The different corrections may either be provided in a single element or separately in different elements. The higher order corrections could be provided to a surface of the optical apparatus. This could be in addition to or instead of providing a separate prescription element.

In the set of embodiments in which a fluid filled lens is provided, the fixed power prescription element(s) could comprise the protective cover(s) for the lens, e.g. if a double membrane lens was being used or as a cover for a single membrane lens. Alternatively it could be attached to the cavity wall or it could comprise the cavity wall opposite a membrane if a single membrane lens was being used. This latter option is preferable as it does not add an extra optical component to the lens, i.e. a cavity wall is needed in a single membrane lens, so it is advantageous that this comprises a fixed power prescription element. As discussed previously, providing a prescription element can help to reduce the total range of the variable power lens, which in a fluid filled lens means that less fluid is needed, which helps to reduce the size of the lens. It is also easier to manufacture a single membrane lens than a double membrane lens.

If the fixed power prescription element(s) are provided as protective cover(s) for the fluid filled lens, these could be detachable to enable the prescription elements to be interchanged easily to suit different user's prescriptions, e.g. if the apparatus is being used in a hospital repeatedly for different users.

In the set of embodiments in which an Alvarez lens is provided, a fixed power prescription element could be included in either the Alvarez or non-Alvarez surfaces of the lens as one or more added fixed power terms in the mathematical description of the surface. Alternatively or additionally, a prescription element could be included as part of a cover or protective enclosure for the Alvarez lens.

In the set of embodiments in which a variable electroactive lens is provided, a fixed power prescription lens could comprise part of the optical material that forms the electroactive lens, e.g. through conventional grinding of one or more of the optical surfaces to give the required power. The electroactive part of the lens could be enclosed within a sandwich of optical elements whose powers result in the required prescriptive power.

In some embodiments the means for adjusting the power of the variable power lens is mechanically operated by a user. The precise mechanism can be chosen to suit the type of lens used. For example if the lens is fluid filled the adjustment means might comprise one of a pump, syringe, rack and pinion, plunger, e.g. a screw driven plunger, cam-operated actuator, bladder or bellows. Syringes are simple mechanisms but there is a risk of fluid leaks and/or air ingress which causes a drop in the power range of the variable lens or (in the case of air ingress) impair the responsiveness of the lens (owing to the lag cause by bubble expansion and contraction during adjustment). A fully sealed system, such as a bladder or bellows, avoids a moving seal as is necessary in a syringe.

If the lens is an Alvarez lens or a diffractive Alvarez lens, the adjustment means could comprise e.g. a screw, cam or slider an actuator to move the two sections of the lens relative to each other. In an Alvarez lens either both or only one of the lens elements can be moved to adjust the lens. It may be preferable to move both lens elements as moving just one introduces a small amount of prism, although this may be tolerable if moving both lens elements is more complicated or expensive.

In other embodiments, instead of being mechanically operated the adjustment means could be operated by a motor, solenoid or other electrically-operated actuator. Such an actuator could be controlled by a user by means of a control interface comprising a dial, lever, slider, buttons or the like. The interface could be on the eyewear or on a separate wired or wireless (e.g. Bluetooth, RF, infra-red, etc. controller). Similarly if the lens is an electroactive lens, the electric field across the lens can be controlled by such a control interface.

In accordance with the invention means are provided to capture data representing the adjustments made to the power of the lens(es). In general these data could either relate to the absolute power of the lens in question—such that adjustments can be inferred from comparing successive data—or the data could relate to the actual adjustments made.

In the former case of the data representing the power of the lens, this could theoretically comprise an actual value for the power itself—e.g. measured by an on-board auto-refractor. More typically etc. it would comprise some other physical parameter exhibiting a known relationship to the power.

In one set of embodiments comprising a fluid-filled lens, a pressure sensor is provided to measure the pressure of the fluid in or near the lens cavity, the data thus comprising pressure data. This pressure measurement can then be converted into a lens power measurement. The advantage of measuring the pressure is that it gives a more direct measurement (via a known or calibrated relationship) of the lens power than other indirect measurements. Pressure sensing also takes into account changes in optical power brought about by changes in the geometry of the total fluid volume, e.g. through fluid pipes being bent, that would not be noticed if using, for example, a displacement sensor.

If an Alvarez lens is used, the data capture means could comprise a linear displacement sensor arranged to determine the linear displacement of the lens elements—either directly or through sensing the position of an adjustment mechanism. Linear displacement measurement works well for an Alvarez lens as the lens's power is directly linked to the relative linear position of the lens elements.

If an electroactive lens is used, the data capture means could comprise means for measuring the applied electric field—again either directly or through measuring an intermediate control signal.

As mentioned above the data captured could alternatively represent the adjustments made to the power rather than the absolute value. This is most conveniently achieved where the lens power is controlled electronically by a user interface; the control signals may then simply be logged, e.g. by the control circuitry, as record of the adjustments made. Where a mechanical adjustment is made, this could be logged either by measuring movement of an actuating element such as a lever, knob, syringe plunger or the like, or by measuring say the flow of fluid into or out of a fluid-filled lens. The data capture means might then comprise a volume flow sensor.

The means for capturing data may additionally comprise means for measuring the angle at which the apparatus is being used, e.g. a tilt sensor or inclinometer. This could give information on whether a user is been looking ahead or down while adjusting the power of the lens, which can either be used as an additional piece of data from the measurement, or can be used to correct or calibrate the measured adjustment in the optical power of the lens. Such a measurement is useful because the amount by which the power of the lens is adjusted may depend on whether the user is looking in the near distance, e.g. reading when the user is likely to be looking down, or the far distance, e.g. the television when the user is likely to be looking straight ahead.

An alternative way of determining whether the user is looking in the near or far distance could be that the means for capturing data comprise means for estimating the distance from the user's eyes to the object they are viewing, e.g. an infrared or ultrasonic rangefinder.

The means for capturing data may additionally comprise means for measuring the vergence of the eyes. The eyeballs rotate towards each other (converge) to allow a person to view a close object or rotate away from each other (diverge) to allow a person to view a distant object. The vergence of the eyes is closely coordinated with the accommodation of the eyes, i.e. the refractive state of the eyes. Therefore if the vergence of the eyes is measured, this can give additional data as to the refractive state of the eyes.

There are a number of ways in which the vergence of the eyes can be measured. In one set of embodiments the means for measuring the vergence of the eyes comprises a machine vision system that tracks the pupil and/or the corneal limbus. In another set of embodiments the means for measuring the vergence of the eyes comprises a reflection-based system that monitors changes in light reflecting from the eye's surface, e.g. by shining infrared light emitting diodes (IR LEDs) onto the eye and measuring the reflection response.

In such a reflection-based system, at least one (preferably three or four) IR LED and corresponding photodiode sensor are provided on the apparatus. The or each IR LED is aimed at a portion of the eyeball (particularly the cornea) such that a portion of the IR light is reflected back at the photodiode and the amount of the reflected light changes measurably as the eyeball moves, e.g. because of different amounts of reflection from the sclera and cornea. If at least three IR LED and photodiode pairs are provided then this enables measurements to be taken which distinguish between up and down movement, and left to right movement.

Therefore in these sets of embodiments more than one piece of data could be measured, with all of these pieces of data being recorded or transmitted.

In one set of embodiments the data is captured at fixed time intervals throughout the day, e.g. once every ten minutes. In another set of embodiments the data is captured after the user has adjusted the power of the lens. A combination of these two schemes could equally be used.

In a preferred set of embodiments the means for capturing data comprises means to measure the time at which the data was captured. This is particularly useful when the data are stored for later analysis as it allows the captured power adjustment data to be associated with a time at which the measurement was made which could assist in diagnosis or understanding of a condition.

Depending on the type of the variable power lens used, the apparatus may need to be calibrated. The aim of calibration is to check the power range of the lens against the desired power range and also to determine the relationship between the optical power and the adjustment means, e.g. the data being captured. The calibration can be performed with a conventional lens meter (which may use one of a number of techniques) to measure the optical power of the lens or any other suitable method, e.g. wavefront sensing. The calibration could be performed manually or automatically, and may be done more than once over the lifetime of the apparatus. Although calibration is more relevant to fluid filled or Alvarez lenses, even electroactive lenses need to be checked that they lie within the specified range.

In one set of embodiments the apparatus comprises data recording means e.g. a data logger for recording the captured data for subsequent downloading or transmission. The data recording means could comprise a hard disk drive or solid state memory such as a random access memory (RAM) module memory card; could be permanent or removable.

The data recorded by the data recording means could, in a simplistic embodiment, simply be displayed on a suitable display (e.g. for manually recording by a user or professional practitioner). Preferably the apparatus is arranged such that recorded data can be transferred from the optical apparatus to means for processing the data, e.g. a computer, when required. Preferably the data recording means has the capacity to record data for at least a 24 hour period, e.g. at least a 48 hour period or at least a week. This enables the apparatus to record data continuously over a long period of time, i.e. recording a series of measurements of the captured data, without needing to transfer the data from the apparatus to free up space for new data to be recorded.

A user can transfer the data from the apparatus at regular intervals or, if the capacity of the data recording means allows, wait until they have an appointment with a clinician when the data can be transferred. However this is not essential as there may be some circumstances where it is only necessary to record the latest change, e.g. in a hospital situation where the user was regularly being checked, and therefore the data recording means need only display the current value of the captured data.

The recorded data could be manually transferred from the optical apparatus—e.g. by removing a memory card or connecting a detachable cable such as USB. Alternatively the apparatus could comprise wireless transmitting means, e.g. Bluetooth, RF, infra-red, etc. for transmitting the recorded data from the apparatus. The data could be transmitted to a PC or a handheld device, e.g. mobile phone or personal digital assistant, or could be transmitted to a public network such as a GSM, 3G or other network. Such wireless transmission is equally applicable where data is transmitted real time—either in addition to or instead of being stored.

In order to make the optical apparatus more suitable for shared use and more easily adaptable for a user's needs, in the sets of embodiments in which two lenses are provided, e.g. a pair of spectacles, the apparatus could comprise means for altering the distance between the optical centres of the lenses. The distance between a person's two pupils in known as the interpupillary distance (IPD), which depends on their age, gender and racial group, as well as changing depending on whether they are looking at a close or distant object (owing to the vergence of the eyes). Ideally in an optical apparatus with two lenses, the distance between the optical centres of the lenses should match the wearer's IPD. Therefore by providing means for changing this distance on the apparatus allows a user to customise the apparatus to best suit their IPD. Small mismatches between a person's IPD and that of their glasses is not normally a problem at low optical powers, but this may be an issue where the power of the corrective lenses is large or where the distance mismatch is large.

The means for altering the distance between the optical centres of the lenses preferably allow the optical centres to be moved between 50 mm and 75 mm apart from each other. In one set of embodiments the altering means could comprise a screw thread between the lenses which alters the distance between the optical centres. In another set of embodiments the altering means could comprise a ratchet-based adjustment system with discrete positions for the lenses. In another set of embodiments the altering means could comprise a sliding mechanism with a clamp or brake to position the lenses as required. In another set of embodiments the altering means could comprise a hinge, e.g. as for binoculars, to allow the lenses to rotate relative to each other and thereby alter the distance between them. In another set of embodiments the altering means could comprise a detachable nose or brow bar, with different lengths of bar being provided to alter the distance between the lenses. In another set of embodiments the altering means could comprise a lateral adjustment mechanism on a supporting brow bar.

Certain preferred embodiments of the invention will now be described, by way of example only, with reference to the accompanying drawings in which:

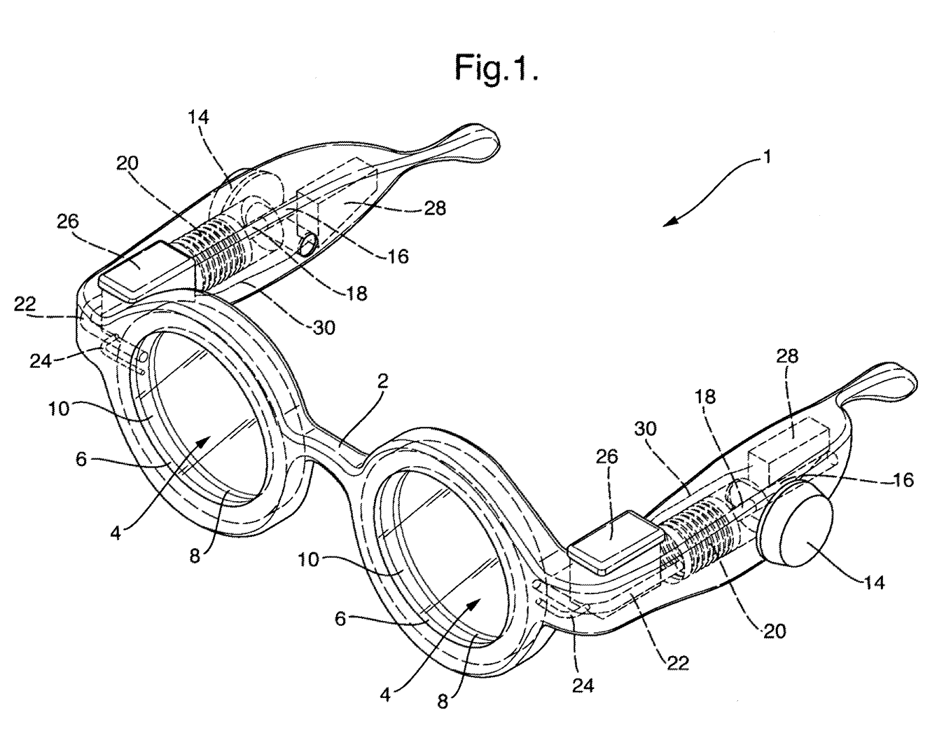

FIG. 1 shows a perspective view of an embodiment in accordance with the present invention;

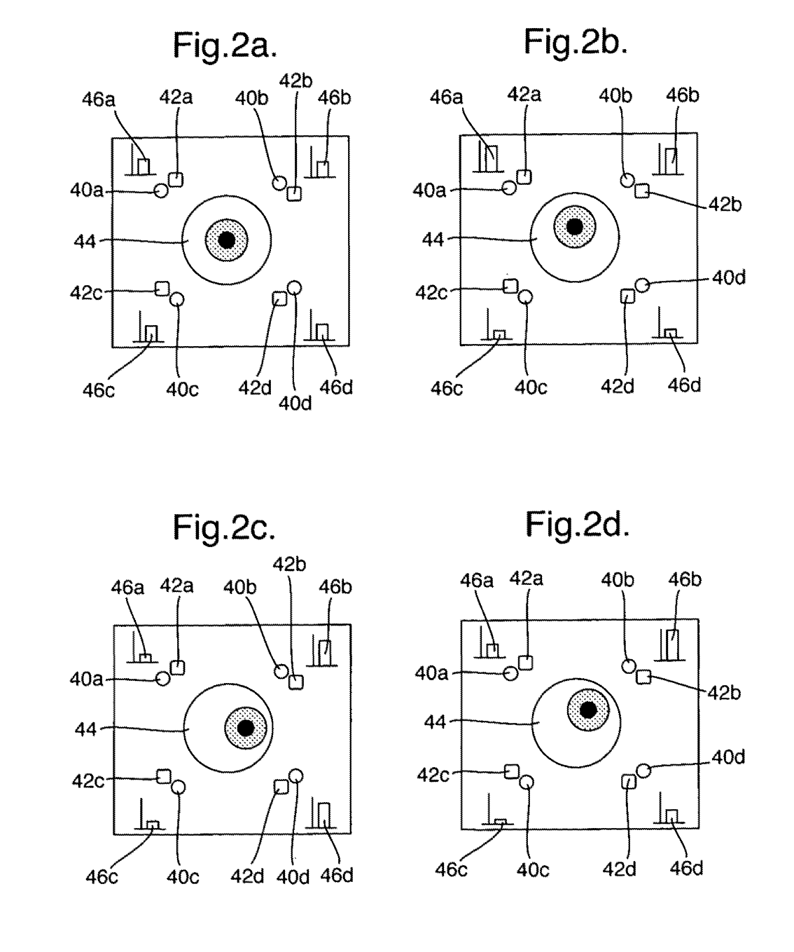

FIGS. 2a, 2b, 2c and 2d show schematic diagrams of a detection system to determine the vergence of a user's eyes; and

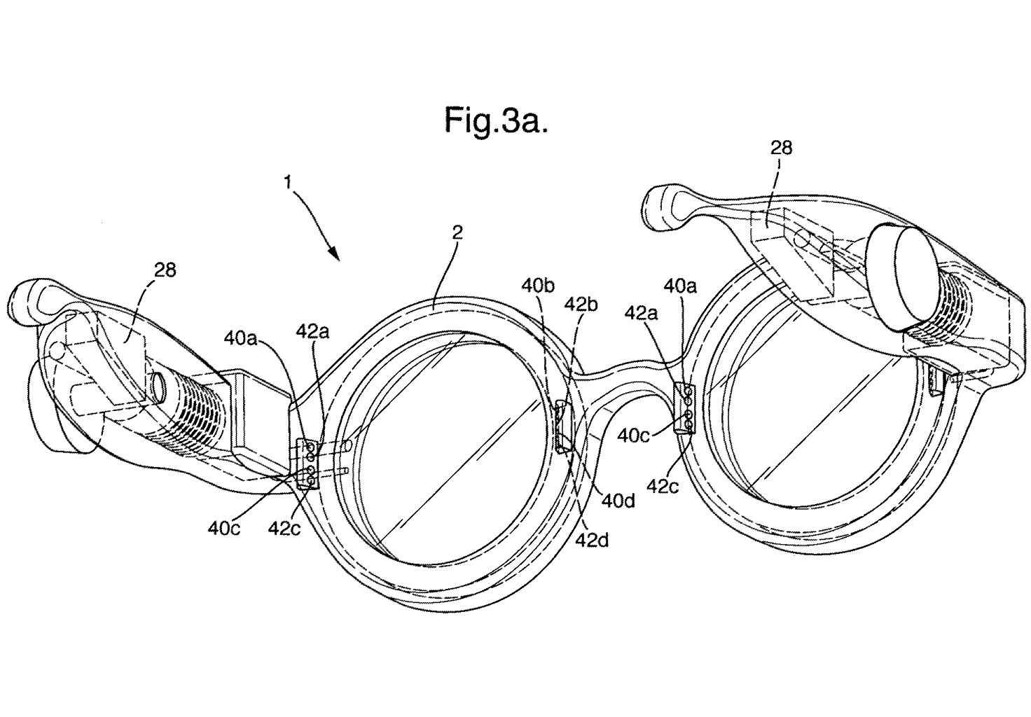

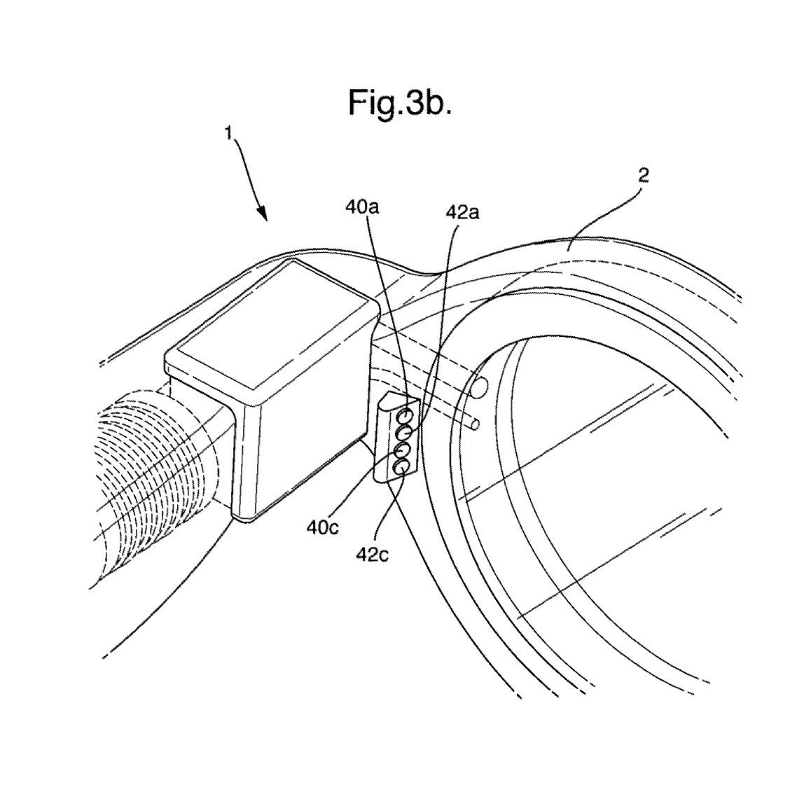

FIGS. 3a and 3b show a perspective view of a pair of spectacles incorporating a vergence detection system.

FIG. 1 shows a perspective view of the main components of a pair of spectacles 1 embodying the present invention. The spectacles 1 comprise a frame 2, a variable power lens 4 for each eye, a front cover 6 and a rear cover 8. Either the front cover 6 or rear cover 8 can include a fixed prescription element, and both can offer protection to the variable power lens 4.

Each of the variable power lenses 4 is a fluid filled lens which comprises a fluid filled cavity 10 held sealed between the front cover 6 and the rear cover 8. The adjustment means for the variable power lens 4 comprises a rotatable knob 14 which is connected to a rack and pinion arrangement 16. On the end of the rack is mounted a plunger 18 which is arranged to act on a set of bellows 20 in the arms of the spectacles. The bellows 20 are connected via a first fluid channel 22 to the fluid filled cavity 10 in the lens 4.

A second fluid channel 24, connects the fluid filled cavity 10 in the lens 4 to a pressure sensor 26. The pressure sensor 26 is connected to a data logger and transmitter 28 via a wire 30.

Operation of the embodiment shown in FIG. 1 will now be described. A user places the pair of spectacles 1 in front of their eyes like any normal pair of spectacles. The variable power lenses 4 allow the user to adjust the power of the variable power lenses 4 to suit their optical prescription. This is achieved by turning the rotatable knob 14 which acts on the plunger 18 via the rack and pinion 16. The plunger 18 either increases or decreases the volume of fluid in the bellows 20 depending on which direction the rotatable knob 14 is turned. The change in volume of fluid in the bellows 20 changes the volume of fluid in the fluid filled cavity 10 in the variable power lens 4 as they are connected by the first fluid channel 22. The change in volume of fluid in the fluid filled cavity 10 in the variable power lens 4 adjusts the power of the variable power lens 4. If more fluid is pumped into the fluid filled cavity 10 the power of the variable power lens 4 increases; if fluid is withdrawn from the fluid filled cavity 10 the power of the variable power lens 4 decreases. It can therefore be seen that the user can easily adjust the variable power lenses 4 to suit their prescription simply by turning the rotatable knobs 14 associated with each of the variable power lenses 4 until they can see objects through the spectacles in clear focus.

When the user experiences a fluctuation in their vision, he or she can adjust the variable power lenses 4 as before to correct the fluctuation and enable them to see in clear focus again. Since each lens 4 is adjustable individually this allows for differential adjustments which take account of differing prescriptions for each eye as well as the different fluctuations in vision experienced by each eye.

Accompanying the change in volume of the fluid filled cavity 10 in the variable power lens 4 is a change in pressure of the fluid in the fluid filled cavity 10. If more fluid is pumped into the fluid filled cavity 10 the pressure in the fluid filled cavity 10 cavity increases; if fluid is withdrawn from the fluid filled cavity 10 the pressure decreases. The pressure change for each adjustment of the lens 4 is measured by the pressure sensor 26, which senses the pressure of the fluid filled cavity 10 in the variable power lens 4 via the second fluid channel 24 connecting them. The pressure measurements and sent to and recorded by the data logger 28 which is connected to the pressure sensor 26 by a wire 30. The data logger is able to record the changes in pressure measurements and the time at which the pressure changes occurred. The recorded data are then transmitted wirelessly to a remote computer where the data can be analysed to show the fluctuations in a user's vision over a period of time. The recorded pressure measurements are converted into optical power measurements using a known relationship between the pressure and the optical power for the lenses 4 in the spectacles 1.

Therefore it can be seen that the spectacles 1 can record all the adjustments that are made to the optical power of the variable power lenses 4. Once these data have been recorded and transmitted to a remote computer, a clinician can then use the data to monitor the fluctuations in a user's vision which can help in diagnosing a possible condition in the user. The data can also be collected on a statistical basis to inform research into conditions involving refractive excursions.

FIGS. 2a, 2b, 2c and 2d show schematic diagrams of a detection system which can be used to determine the vergence of a user's eyes and therefore give an estimate of the distance from the user's eyes to the object they are viewing. As the vergence of the eyes is closely related to their refractive state, measuring the vergence can give additional data as to the refractive state of the eyes. The same detection system is shown in each of FIGS. 2a, 2b, 2c and 2d, and comprises four pairs of infrared (IR) LED emitters 40a, 40b, 40c, 40d and photodiode sensors 42a, 42b, 42c, 42d positioned in complementary pairs around an eyeball 44. The IR LED emitters 40a, 40b, 40c, 40d and photodiode sensors 42a, 42b, 42c, 42d are suitably mounted on the frame of a pair of spectacles as shown FIGS. 3a and 3b.

The IR LED emitters 40a, 40b, 40c, 40d and photodiode sensors 42a, 42b, 42c, 42d are arranged to detect changes in the direction in which the eyeball 44 is looking. This is achieved by directing the IR LED emitters 40a, 40b, 40c, 40d at the eyeball 44 and detecting changes in the reflection responses 46a, 46b, 46c, 46d from the IR light on the sclera and cornea of the eyeball 44 with the photodiode sensors 42a, 42b, 42c, 42d. FIG. 2a shows an eyeball 44 looking straight ahead, and therefore the reflection response 46a, 46b, 46c, 46d are the same for each of the photodiode sensors 42a, 42b, 42c, 42d. FIG. 2b shows an eyeball 44 looking straight upwards, with the responses 46a, 46b for the two upper photodiode sensors 42a, 42b being greater than the responses 46c, 46d for the two lower photodiode sensors 42c, 42d. FIG. 2c shows an eyeball 44 looking right, with the responses 46b, 46d for the two right photodiode sensors 42b, 42d being greater than the responses 46a, 46c for the two left photodiode sensors 42a, 42c. FIG. 2d shows an eyeball 44 looking upwards and to the right and therefore the response 46b for the upper right photodiode sensor 42b is the highest, greater than the responses 46a, 46d for the upper left and lower right photodiode sensors 42a, 42d, which are in turn greater than the response 46c for the lower left photodiode sensor 42c.

These reflection responses 46a, 46b, 46c, 46d can be measured and recorded in the same way as the rest of the data to provide data as to the changes in the refractive state of a user's eyes.

FIG. 3a shows a perspective view of a pair of spectacles incorporating a vergence detection system, with FIG. 3b showing a close-up view of the vergence detection system. The spectacles 1 are of similar construction to those shown in FIG. 1, except that two pairs of IR LED emitters 40a, 40b, 40c, 40d and photodiode sensors 42a, 42b, 42c, 42d are mounted on the part of the frame 2 either side of the lenses 4. Each of the pairs of IR LED emitters 40a, 40b, 40c, 40d and photodiode sensors 42a, 42b, 42c, 42d are connected to the respective data logger 28 in the arms of the frame 2 by a wire (not shown) to record the data measured. These IR LED emitters 40a, 40b, 40c, 40d and photodiode sensors 42a, 42b, 42c, 42d operate in the same manner as has been described previously in relation to FIGS. 2a, 2b, 2c and 2d.

It will be appreciated by those skilled in the art that only a small number of possible embodiments have been described and that many variations and modifications are possible within the scope of the invention. For example any type of variable power lens suitable for using in the apparatus can be used, with any means suitable for adjusting the lens. The data captured by the apparatus can be chosen to be any suitable for the type of variable power lens and associated adjustment means being used.

1. An optical apparatus for wearing by a human user comprising one or more variable power lenses, an arrangement for adjusting the power of the variable power lens, an arrangement for capturing data representative of said adjustments, and a data recorder or transmitter for recording or transmitting the captured data.

2. An optical apparatus as claimed in claim 1, wherein the arrangement for adjusting the power of the variable power lens comprises an arrangement for allowing user adjustment of the power of the variable power lens.

3. An optical apparatus as claimed in claim 1, wherein separate variable power lenses are provided for each eye.

4. An optical apparatus as claimed in claim 3, comprising an arrangement for altering the distance between the optical centres of the lenses.

5. An optical apparatus as claimed in claim 1, wherein the or each variable power lens comprises a fluid filled lens, an Alvarez-based lens, an electroactive lens, a diffractive lens or a diffractive Alvarez lens.

6. An optical apparatus as claimed in claim 1, wherein the or each variable power lens comprises one or more fixed power prescription elements.

7. An optical apparatus as claimed in claim 6, wherein the one or more fixed power prescriptions element comprises one or more components from a spherical correction, a cylinder and axis correction or any other higher order aberration correction.

8. An optical apparatus as claimed in claim 1, wherein the arrangement for adjusting the power of the variable power lens is mechanically operated by a user.

9. An optical apparatus as claimed in claim 1, wherein the arrangement for adjusting the power of the variable power lens is operated by a motor, solenoid or other electrically-operated actuator.

10. An optical apparatus as claimed in claim 1, comprising an arrangement for measuring the angle at which the apparatus is being used.

11. An optical apparatus as claimed in claim 1, comprising an arrangement for estimating the distance from the user's eyes to the object they are viewing.

12. An optical apparatus as claimed in claim 1, comprising an arrangement for measuring the vergence of the eyes.

13. An optical apparatus as claimed in claim 1, wherein the arrangement for capturing data comprises an arrangement to measure the time at which the data was captured.

14. An optical apparatus as claimed in claim 1, wherein the apparatus is arranged such that recorded data can be transferred from the optical apparatus to a data processor.

15. An optical apparatus as claimed in claim 14, wherein the data recorder has the capacity to record data for at least a 24 hour period, e.g. at least a 48 hour period or at least a week.

16. A method of correcting fluctuating vision of a human user, the method comprising providing an optical apparatus comprising one or more variable power lenses, adjusting the power of said lens to enable the human user to see in clear focus, capturing data representative of said adjustments, and recording or transmitting the captured data.

17. A method as claimed in claim 16, wherein comprising a user adjusting the power of the variable power lens.

18. A method as claimed in claim 16, wherein separate variable power lenses are provided for each eye.

19. A method as claimed in claim 18, comprising altering the distance between the optical centres of the lenses.

20. A method as claimed in claim 16, wherein the or each variable power lens comprises a fluid filled lens, an Alvarez-based lens, an electroactive lens, a diffractive lens or a diffractive Alvarez lens.

21. A method as claimed in claim 16, wherein the or each variable power lens comprises one or more fixed power prescription elements.

22. A method as claimed in claim 21, wherein the one or more fixed power prescriptions element comprises one or more components from a spherical correction, a cylinder and axis correction or any other higher order aberration correction.

23. A method as claimed in claim 16, comprising the user mechanically adjusting the power of the variable power lens.

24. A method as claimed in claim 16, comprising adjusting the power of the variable power lens by a motor, solenoid or other electrically-operated actuator.

25. A method as claimed in claim 16, comprising measuring the angle at which the apparatus is being used.

26. A method as claimed in claim 16, comprising estimating the distance from the user's eyes to the object they are viewing.

27. A method as claimed in claim 16, comprising measuring the vergence of the eyes.

28. A method as claimed in claim 16, comprising measuring the time at which the data was captured.

29. A method as claimed in claim 16, comprising transferring recorded data from the optical apparatus to a data processor.

30. A method as claimed in claim 16, comprising recording data for at least a 24 hour period, e.g. at least a 48 hour period or at least a week.
